(19) United States
(12) Patent Application Publication
(10) Pub. No.: US 2005/0193205 A1
(43) Pub. Date: Sep. 1, 2005

(54) Method and system for session based watermarking of encrypted content

(75) Inventors: Andre Jacobs, Redmond, WA (US); Oscar V. Zhuk, Bellevue, WA (US); Glenn A. Morten, Bellevue, WA (US); Eric B. Shapiro, Ann Arbor, MI (US)

Correspondence Address: DARBY & DARBY P.C., P. O. BOX 5257, NEW YORK, NY, 10150-5257, US

(73) Assignee: Widevine Technologies, Inc., Seattle, WA (US)

(21) Appl. No.: 11/012,463

(22) Filed: Dec. 14, 2004

Related U.S. Application Data
(60) Provisional application No. 60/535,357, filed on Jan. 9, 2004.

(51) Int. Cl. H04L 9/00; G06F 15/16

(52) U.S. Cl. 713/176; 726/10

(57) ABSTRACT

A method and apparatus applies a variety of session based watermarks in real-time to content that is streamed from a server towards a client. The invention employs content where differing targeted portions are selectively encrypted, such that other portions remain in the clear (unencrypted). Session information, such as an intended client, end-user, operator of a content server, content owner, and the like, may be used to generate the various watermarks. The watermarks may also be digitally signed and/or encrypted. The watermarks may be applied to the portions of the clear content as the content is streamed towards the client. In one embodiment, a bridge server is configured to modify packets of streaming media data files with the variety of watermarks. In another embodiment, the content server for the streaming media data includes a plug-in component that dynamically modifies the packets of streaming media data files with the variety of watermarks.

### CROSS-REFERENCE TO RELATED APPLICATIONS

This application claims the benefit of U.S. Provisional Application Ser. No. 60/535,357 filed on Jan. 9, 2004, the benefit of the earlier filing date of which is hereby claimed under 35 U.S.C. § 119 (e) and further incorporated by reference.

### FIELD OF THE INVENTION

The present invention relates generally to digital copy protection, and more particularly to dynamically modifying streaming targeted selectively encrypted content with a watermark.

### BACKGROUND OF THE INVENTION

The development of the Internet has created great opportunities for the sharing of digital information. Recently, audio and video digital information has become more widely available on the Internet, in the form of streaming media, further increasing the popularity of the Internet.

Streaming media is an Internet data transfer technique that allows an end user to see and hear audio and video information without lengthy download times. The host or source “streams” small packets of information over the Internet to the end user, who can access the content as it is received. Typically, for large streaming media data files, temporary files are not created on the end user device. Rather, small packets of streaming media information are typically cached in buffers on an end user device and discarded shortly after the information is seen or heard.

Many businesses, artists, and individuals post copyrighted material on the Internet in the form of streaming media each day. Virtually anybody who is able to use a PC can read, copy, edit, and even repost the streaming media data files they accessed from the Internet. Unfortunately, tens of thousands of these copyrighted streaming media data files are copied wholesale by unauthorized practices every day. Such digital media piracy is a growing concern resulting in millions of lost dollars to businesses and individuals.

Moreover, as an unauthorized streaming media data file may be transferred to multiple Internet users, it is often extremely difficult to determine the original source of the digital media piracy. Thus, it is with respect to these considerations and others that the present invention has been made.

### BRIEF DESCRIPTION OF THE DRAWINGS

Non-limiting and non-exhaustive embodiments of the invention are described with reference to the following drawings. In the drawings, like reference numerals refer to like parts throughout the various figures unless otherwise specified.

For a better understanding of the invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a server device that may be employed in a system implementing the invention;

FIG. 3 illustrates one embodiment of functional components of content at various stages of its progression through the invention; and

FIG. 4 illustrates a logical flow diagram generally showing one embodiment of a process for managing session based watermarking on targeted selectively pre-encrypted content, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Briefly stated, the present invention generally relates to a method and apparatus for applying a session based watermark in real-time to content that is streamed from a server towards a client. The invention employs content with differing targeted portions being selectively encrypted, such that other portions of the content remain in the clear (unencrypted). Session information, including information associated with an intended client, end-user, operator of a content server, content owner, and the like, may be used to generate at least one unique watermark. The watermark may be applied to a portion of the clear content as the content is streamed towards the client. The watermark may later be used to trace a source of the content, ownership of the content, improper access of the content, improper alteration of the content, and so forth. In one embodiment, a watermarking bridge is configured to modify packets of streaming content with a variety of session based watermarks. In another embodiment, the content server for the streaming content includes a watermarking plug-in component that dynamically modifies the packets of streaming content with at least one session based watermark. In addition, at least a portion of the watermark may be encrypted, and/or digitally signed. This is directed at further enabling authentication and/or non-repudiation of the watermark during a forensic analysis. In addition, by watermarking the content on a server side, rather than on a client side, the invention virtually eliminates any requirement for a trusted watermarking client.

Illustrative Environment

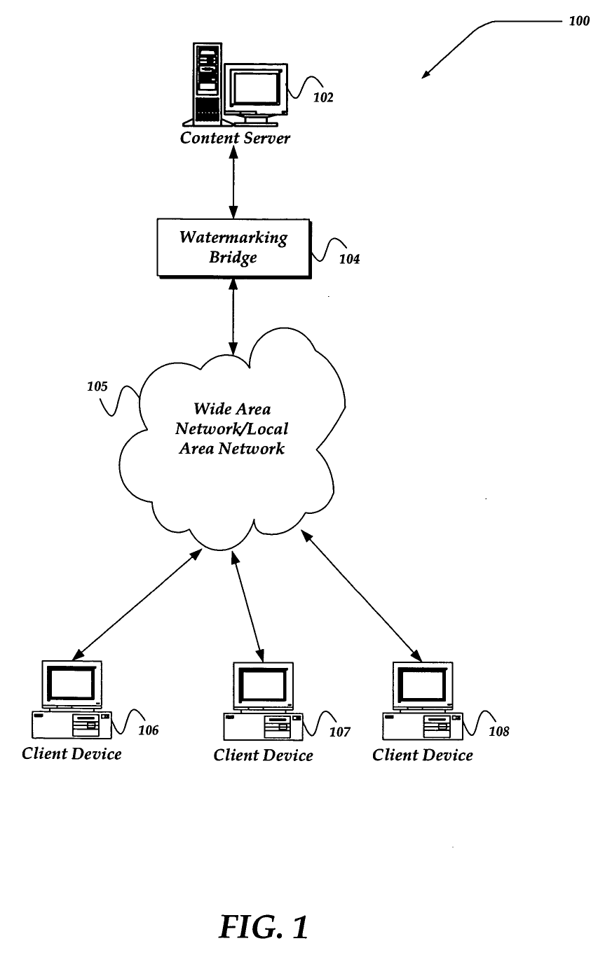

FIG. 1 shows a functional block diagram illustrating one embodiment of operating environment 100 in which the invention may be implemented. Operating environment 100 is only one example of a suitable operating environment and is not intended to suggest any limitation as to the scope of use or functionality of the present invention. Thus, other well-known environments and configurations may be employed without departing from the scope or spirit of the present invention.

As shown in the figure, operating environment 100 includes content server 102, watermarking bridge 104, network 105, and clients 106-108. Network 105 is in communication with watermarking bridge 104 and clients 106-108. Watermarking bridge 104 is in further communications with content server 102.

Content server 102 includes virtually any computing device that is configured for use by a producer, developer, and/or owner of content that can be distributed to client devices 106-108. Such content, includes, but is not limited to, motion pictures, movies, videos, music, pay per view (PPV), video on demand (VoD), interactive media, audios, still images, text, graphics, and other forms of digital content directed towards a user of a client device, such as client devices 106-108. Such content, for example, may be streamed towards a requesting client device, using any of a variety of streaming mechanisms.

Content server 102 may also be configured for use by businesses, systems, and the like, that obtain rights from a content owner to copy and distribute the content. Content server 102 may obtain the rights to copy and distribute from one or more content owners. Content server 102 may repackage, store, and schedule content for subsequent sale, distribution, and license to other content providers, users of client devices 106-108, and the like. As such, although not illustrated, content server 102 may receive content from an ‘upstream’ device.

Content server 102 is configured to receive a request for content from a client device, such as client devices 106-108, and to stream the content towards the requesting client device. In one embodiment, content server 102 may receive the content from the upstream device in a targeted selectively pre-encrypted format as is described further below. In another embodiment, content server 102 may be configured to target for selective encryption at least some of the content, prior to streaming the content towards a requesting client device, such as client devices 106-108. In another embodiment, content server 102 may encrypt the content as it is being streamed towards the requesting client device.

Devices that may operate as content server 102 include personal computers, desktop computers, multiprocessor systems, microprocessor-based or programmable consumer electronics, network PCs, servers, and the like.

Watermarking bridge 104 is configured to receive streaming content, such as from content server 102, and to dynamically modify the streaming content, in part, by including at least one watermark to the streaming content. In one embodiment, watermarking bridge 104 received targeted selectively encrypted content to which the watermark is to be applied. Watermarking bridge 104 may then enable the continued flow of the watermarked streaming content toward a requesting client, such as clients 106-108. Watermarking bridge 104 may further receive information about an end-user of the client device, an owner of the content, an owner of content server 102, and the like, and employ at least some of the received information to generate at least one watermark. Watermarking bridge 104 may be further configured to employ a variety of watermarking mechanisms to include the at least one watermark in the streaming content.

Devices that may operate as watermarking bridge 104 include a chip based product, an application residing within a personal computer, desktop computer, multiprocessor system, microprocessor-based or programmable consumer electronics, network PC, server, and the like. As such, in one embodiment, watermarking bridge 104 may include memory, a storage device, a transceiving component, and a processor that is configured to execute the application.

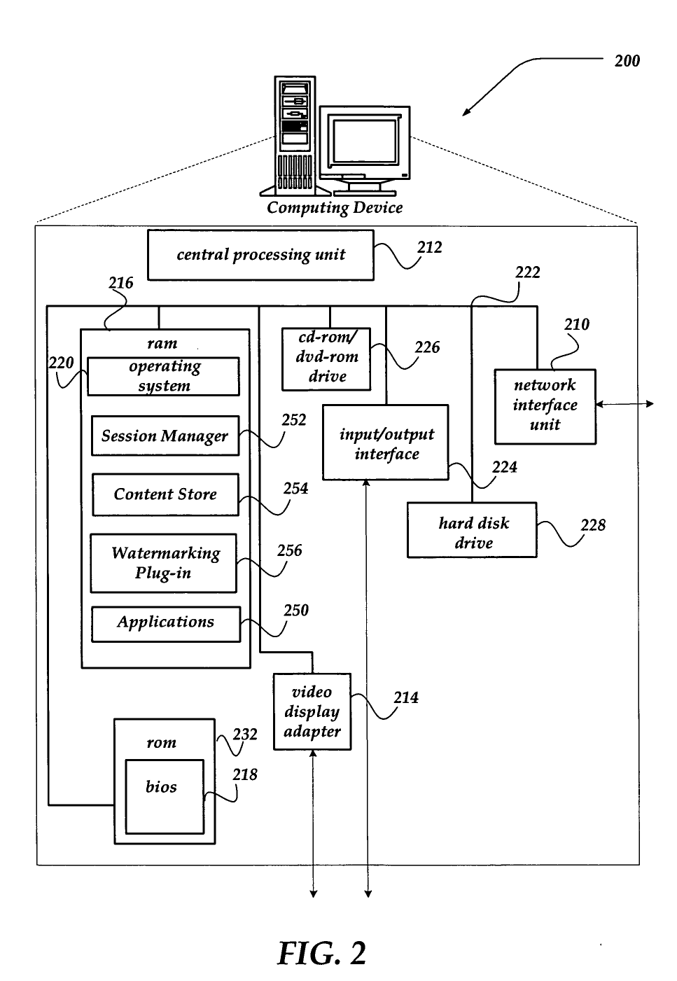

Moreover, although watermarking bridge 104 is illustrated in FIG. 1 as distinct from content server 102, the invention is not so limited. For example, watermarking bridge 104 may be included within content server 102 as a plug-in component, application, chip, board, and the like. As such, one embodiment of a watermarking component within a server device, similar to content server 102, is described in more detail below in conjunction with FIG. 2. Moreover, watermarking bridge 104 (and/or watermarking plug-in) may be configured to reside within an auditable and trusted environment.

Network 105 is configured to couple one computing device to another computing device to enable them to communicate. Network 105 is enabled to employ any form of computer readable media for communicating information from one electronic device to another. Also, network 105 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, connections based on a variety of standards, including IEEE 802.11a, 802.11g, 802.11b, or any other communications links known to those skilled in the art. Furthermore, remote computers and other related electronic devices could be remotely connected to either LANs or WANs via a modem and temporary telephone link. In essence, network 105 includes any communication mechanism by which information may travel between client devices 106-108 and content server 102.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Client devices 106-108 may include virtually any computing device capable of receiving content over a network, such as network 105, from another computing device, such as content server 102, watermarking bridge 104, and the like. Client devices 106-108 may also include any computing device capable of receiving the content employing other mechanisms, including, but not limited to CDs, DVDs, tape, electronic memory devices, and the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, and the like. Client devices 106-108 may also be any device that is capable of connecting using a wired or wireless communication medium such as a PDA, POCKET PC, wearable computer, and any other device that is equipped to communicate over a wired and/or wireless communication medium to receive and play content.

Client devices 106-108 may include a client that is configured to enable an end-user to request content, to receive the content, and to play the content. The client may also provide other actions, including, but not limited to, enabling other components of the client device to execute, enable an interface with another component, device, the end-user, and the like.

As such, client devices 106-108 may employ any of a variety of devices to enjoy such content, including, but not limited to, a computer display system, an audio system, a jukebox, set top box (STB), a television, video display device, and the like. Client devices 106-108 may include, for example, a VoD media player that is configured to receive streaming content data packets. Client devices 106-108 may employ the VoD media player (and/or another device) to process the streaming content data packets to convert them to sound and/or pictures. Client devices 106-108 may also be configured to provide the streaming content as a steady stream to another application (not shown) that converts the content to sound or pictures for the end user.

Client devices 106-108 may further receive the content as targeted selectively encrypted content, such that to enjoy the content, it will need to be decrypted. Thus, in one embodiment, client devices 106-108 may include an application that is configured to enable decryption of the targeted selectively encrypted content.

Illustrative Computing Device

FIG. 2 shows one embodiment of a computing device, according to one embodiment of the invention. Computing device 200 may include many more components than those shown. The components shown, however, are sufficient to disclose an illustrative embodiment for practicing the invention. Computing device 200 may represent, for example, another embodiment of a content server with a watermarking plug-in component.

Computing device 200 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of computing device 200. Any general-purpose operating system may be employed. Basic input/output system (“BIOS”) 218 is also provided for controlling the low-level operation of computing device 200. As illustrated in FIG. 2, computing device 200 also can communicate with the Internet, or some other communications network, such as network 105 in FIG. 1, via network interface unit 210, which is constructed for use with various communication protocols including the TCP/IP protocol. Network interface unit 210 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Computing device 200 may also include an SMTP handler application for transmitting and receiving e-mail, an HTTP handler application for receiving and handing HTTP requests, and an HTTPS handler application for handling secure connections. The HTTPS handler application may initiate communication with an external application in a secure fashion.

Computing device 200 also includes input/output interface 224 for communicating with external devices, such as a mouse, keyboard, scanner, or other input devices not shown in FIG. 2. Likewise, computing device 200 may further include additional mass storage facilities such as CD-ROM/DVD-ROM drive 226 and hard disk drive 228. Hard disk drive 228 may be utilized to store, among other things, application programs, databases, client device configuration information, policy, and the like.

The mass memory also stores program code and data. One or more applications 250 are loaded into mass memory and run on operating system 220. Examples of application programs may include, but is not limited to transcoders, schedulers, calendars, database programs, word processing programs, HTTP programs, audio players, video players, VoD players, decoders, decrypters, PPV players, interface programs to an STB, interface programs to a television, video camera, and so forth. Mass storage may further include applications such as Session Manager (SM) 252, content store 254, and watermarking plug-in 256.

SM 252 is configured to manage a request for content from a client device. As such, SM 252 may receive the request, locate the content, and provide the content to a watermarking component, such as watermarking plug-in 256, a watermarking bridge, and the like.

SM 252 may further receive session information such as an identifier for an intended client device, an end-user, an operator of a content server, a content owner, content identifier, and the like. SM 252 may then provide the session information to the watermarking component for use is generating a watermark.

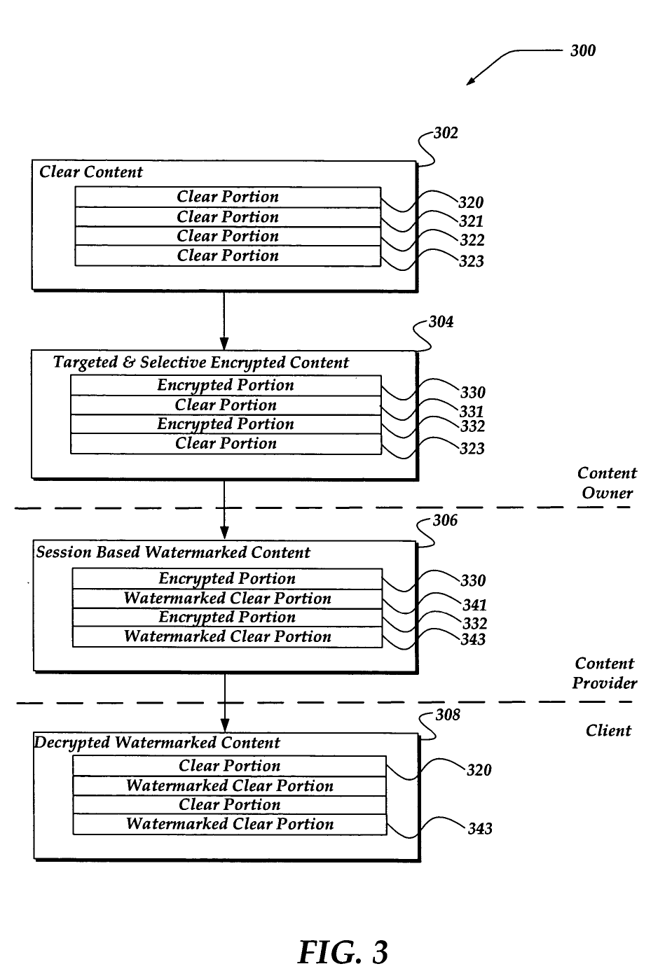

SM 252 may also receive content from an upstream provider. In one embodiment, the received content is targeted selectively pre-encrypted. SM 252 may then store the targeted selectively pre-encrypted content in content store 254. In another embodiment, SM 252 is configured to receive unencrypted content and to perform targeted selective encryption of the content. SM 252 may, for example, examine, parse, and selectively encrypt different targeted portions of the content. SM 252 may, in one embodiment, selectively encrypt the targeted portions of the content in real-time, either as the content is received, and/or as the content is provided to the watermarking component. SM 252 may employ a dynamic targeted selective encryption scheme such as described below in conjunction with FIG. 3. However, SM 252 is not constrained to target selective encryption, and virtually any other mechanism encrypting a portion of the content may be employed without departing from the scope or spirit of the invention.

Content store 254 includes virtually any component configured to enable storage and retrieval of content, including a file, a database, an application, a folder, a document, a directory, and the like.

Watermarking plug-in 256 is configured to provide watermarks to outgoing streaming content prior to transmission to the requesting client. Watermarking plug-in 256 operates substantially similar to watermarking bridge 104 of FIG. 1. For example, watermarking plug-in 256 may employ session information to apply a variety of session based watermarks to the content. Session based watermarking includes applying the watermarks to the content in real-time as the content is streamed from computing device 200 towards the requesting client.

Watermarking plug-in 256 may select and apply a variety of different watermarks to portions of the content that is left in the clear, as described below in conjunction with FIG. 3. Moreover, watermarking plug-in 256 may further encrypt and/or digitally sign the watermarks employing a different cryptographic key than may be employed to encrypt/decrypt the content. Such watermarking cryptographic keys are typically unknown and unavailable to the requesting client, enabling the securing of the watermark from tampering or hostile attacks, as well as enabling authentication and/or non-repudiation of the watermark during a forensic analysis of the content. As such, the client device is unable to decrypt the watermark. In one embodiment, the cryptographic key is a symmetric key; however, asymmetric keys may also be employed without departing from the scope or spirit of the invention.

While watermarking plug-in 256 is illustrated in FIG. 2 as a ‘plug-in’ application to computing device 200, the present invention is not so limited. For example, watermarking plug-in 256 may reside on a separate card, chip, and the like, within computing device 200.

Moreover, although SM 252, content store 254, and watermarking plug-in 256 are illustrated as distinct components, the invention is not so constrained. For example, SM 252 and content store 254 may be implemented as a single integrated component. Moreover, watermarking plug-in 256 may reside in another computing device, such as watermarking bridge 104 of FIG. 1 and be distinct from computing device 200.

Watermarking Streaming Media

Briefly, a session based watermark includes a digital signal or pattern that is inserted into a digital image, audio and/or video data file, or stream. Because the inserted digital signal or pattern is not present in unaltered copies of the original data file, the digital watermark may serve as a type of digital signature for the copied data files. For example, watermarking may be employed to embed copyright notices to the data files. A given watermark may be unique to each copy of the data file so as to identify the intended recipient, or be common to multiple copies of the data file such that the document source may be identified. Moreover, a watermark may be invisible to the casual observer, further facilitating the claim of ownership, receipt of copyright revenues, or the success of prosecution for unauthorized use of the data file.

The traditional approaches to watermarking streaming media data files have required knowledge of the media file formats. Several of the traditional watermarking approaches require uncompressing a streaming media data file (or portions of it) to add the watermark, then recompressing the file (or portions). However, as many of today's streaming media data file formats remain proprietary, and not readily discernable, traditional watermarking approaches are of limited value. However, the present invention provides several approaches to session based watermarking of content that does not require extensive knowledge of the data file formats. In addition, the present invention allows for at least a portion of the streaming content to be pre-encrypted prior to including a watermark, thereby increasing a level of security for the conten.

What follows are several approaches to generating session based watermarks for streaming media data files that are employed by the present invention. Because of the increasing likelihood that a single watermarking technique may be circumvented by improper means, the present invention provides multiple session based watermarking approaches. Moreover, operationally, the present invention is enabled to employ two or more approaches to digitally watermark a given content stream.

A. Generating Substitution frames

1. Preprocessing media files: This approach stores potential replacement frames of the selected streaming content for later substitution. Streaming media data files to be watermarked are scanned and selected frames are extracted. In one embodiment of the invention, each extracted frame from a given streaming media data file is provided with a portion of a serial number, such as a single digit. The serial number may represent a unique identifier of the document source, or the intended client recipient. The portion of the serial number may be located in several frames to reduce confusion that may arise should frames be lost during transmission to client devices 106-108. The serial number digits can also be attached one by one to separate frames.

When a client requests a particular streaming media data file, the selected watermarked frames are employed to replace the unmarked frames in the original streaming media data file.

This approach may be employed in a system such as where a watermarking plug-in resides within the content server. Employing this approach may include parsing the streaming media data file to locate unique information about the requesting client and employing the unique information to create watermarked frames on the fly.

2. Dynamic media data modification: This approach decompresses, modifies, and recompresses streaming media data file data packets. The modified data packets are sent to the requesting client, rather than the original streaming media data file data packets.

3. Dark Frame Replacement: This approach employs knowledge that virtually all long streaming media video data files include black frames. In one embodiment, black frames are stored with watermarks identifying the source of the streaming media video data files. In another embodiment of the invention, black frames are watermarked with a unique requesting client identifier as a client requests the streaming media. The watermarked black frames are employed to replace selected black frames on the fly as the streaming media is transmitted to the requesting client.

4. Common Gateway Interface Application: This approach enables watermarking for web servers to modify downloadable media data file formats or still images and the like.

B. Generating Watermarks for Individual Frames

1. Image/audio Watermarking: This approach provides for insertion of watermarks to still image data formats and audio formats.

2. Metadata Modifications: Metadata provides information about the type of digital data that is being streamed. For example, metadata includes information about the frame rate of the streaming media data file. In one embodiment of this approach, unused data is inserted into the metadata such that a unique watermark is provided to the streaming media. In another embodiment of this approach, the metadata is reordered in a valid but unnatural order that encodes a watermark.

3. Subtractive Watermarking: This approach provides for deliberate dropping of streaming media data frames in a pattern that is recognizable by statistical methods as a watermark. In one embodiment of this approach, in-between frames known as I-frames may be dropped with minimal degradation to the quality of the streaming media.

4. Frame Insertion: Invisible or inaudible watermarked data frames are inserted into the streaming media data file in this embodiment.

5. Appending Useless Data to Packets: Additional useless bytes of information are added to the end of data packets to signify a watermark. The watermark is embedded in the quantity of extraneous bytes that have been added.

6. Appending Useful Data to Packets: This embodiment appends useful data with watermarks to selected streaming media data packets.

C. Generating Serial Numbers for Insertion. These embodiments for embedding watermarks provide selected digits of a unique recipient's identifier, or a source identifier to different streaming media data frames such that a combination of the watermarked data frames include the entire unique identifier.

The present invention, however, is not limited to the above digital session based watermarking techniques. For example, Fourier Transform techniques, Discrete Cosine Transforms, or the like may be employed without departing from the scope or spirit of the present invention.

Generalized Operation

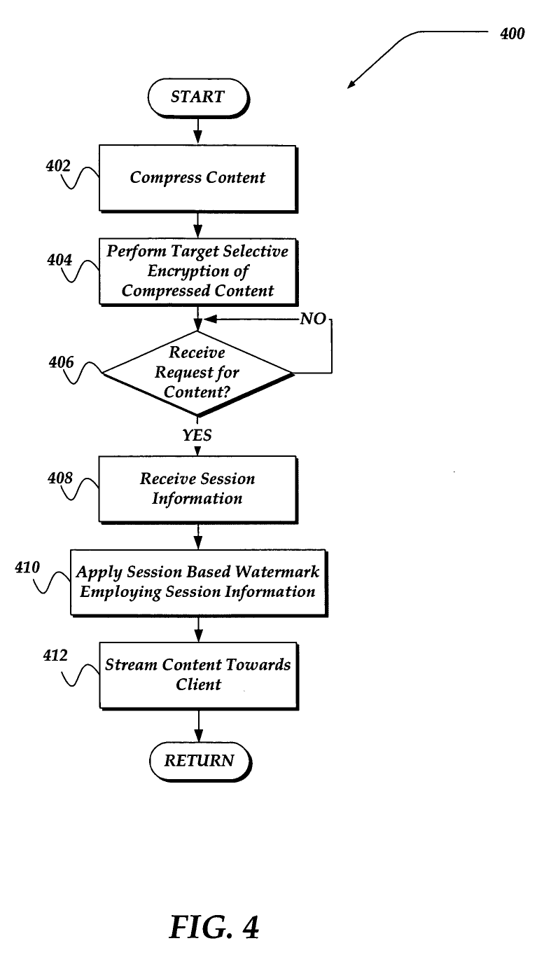

The operation of certain aspects of the invention will now be described with respect to FIGS. 3-4. FIG. 3 illustrates one embodiment of functional components of content at various stages of its progression through the invention. FIG. 3 may be employed as one example of transformation of content as it flows through a session based watermarking mechanism, such as is described in FIG. 4.

As shown in FIG. 3, content transformations 300 include clear content 302, targeted and selectively encrypted content 304, session based watermarked content 306, and decrypted watermarked content 308. In one embodiment, clear content 302 and targeted and selectively encrypted content 304 may reside within a computing device managed by the content owner.

Clear content 302 includes clear portions 320-323. Clear portions 320-323 may represent any of a variety of portions of content 302. Furthermore, clear content 302 may represent a variety of content formats. For example, clear content 302 may be formatted employing Motion Pictures Expert Group (MPEG) format. Clear content 302 is are not limited to MPEG content formats, and other content formats, including JPEG formats, MP3 formats, and the like, may be employed without departing from scope or spirit of the present invention. However, the MPEG format is employed herein as an example and for ease of illustration.

Briefly, MPEG is an encoding and compression standard for digital broadcast content. MPEG provides compression support for television quality transmission of video broadcast content. Moreover, MPEG provides for compressed audio, control, and even user broadcast content.

MPEG content streams include packetized elementary streams (PES), which typically include fixed (or variable sized) blocks or frames of an integral number of elementary streams (ES) access units. An ES typically is a basic component of an MPEG content stream, and includes digital control data, digital audio, digital video, and other digital content (synchronous or asynchronous). A group of tightly coupled PES packets referenced to substantially the same time base comprises an MPEG program stream (PS). Each PES packet also may be broken into fixed-sized transport packet known as MPEG Transport Streams (TS) that form a general-purpose approach of combining one or more content streams, possible including independent time bases. Moreover, MPEG frames include intra-frames (I-frames), forward predicted frames (P-frames), and bi-directional predicted frames (B-frames).

As such, clear portions 320-323 each may include a portion of clear content 302 that is partitioned into units of data based on a variety of criteria. For example, clear portions 320-323 may include portions of data extracted from the video elementary stream (ES), the audio ES, the digital data ES, and any combination of video, audio, data elementary streams of the content stream. For example, clear portions 320-323 may be composed of ten second portions of a video ES. Moreover, clear portions 320-323 need not include the same length, density, and the like, of content from clear content 302.

Targeted and selective encryption may be applied to the video elementary stream (ES), audio ES, digital data ES, and any combination and any portion of video, audio, data elementary streams that comprise clear content 302 to transform it to targeted and selective encrypted content 304. Targeted and selective encryption may further include selectively encrypting at least a portion of an I-frame, P-frame, B-frame, and any combination of P, B, and I frames to generate targeted and selective encrypted content 304. In some instances, however, it may be desired that some portions of the clear content 302 remain in the clear, so that a requesting client device may perform trick plays of the content, such as rewinding, replays, intelligent pausing, and the like. As shown, in FIG. 3, targeted and selective encrypted content 304 shows two portions as encrypted portions (330 and 332).

As targeted and selectively encrypted content 304 streams through watermarking bridge 104 of FIG. 1, watermarking plug-in component 256 of FIG. 2, and the like, at least one session based watermark, as described above, is applied to at least a portion of the clear content (331 and/or 323). By including at least one session based watermark, as described below, targeted and selective encrypted content 304 may be transformed into session based watermarked content 306.

In one embodiment, the targeted and selective encryption may also be applied to a watermark. For example, the watermark may be decomposed into at least two portions. One portion might include most significant bits of an address of a client device. This portion may be targeted for selective encryption. The other portion might include least significant bits of such information as a name of a client, and the like. This portion of the watermark may, for example, remain in the clear. Thus, for example, watermarked clear portions 341 and 343 may further include sub-portions that are in the clear, or further encrypted. Such encryption, however, is likely to employ a cryptographic key that is different from the cryptographic key employed to otherwise encrypt encrypted portions 330 and 332.

When session based watermarked content 306 is received by a requesting client device, encrypted portions 330 and 332 are decrypted to generate decrypted watermarked content 308. Should decrypted watermarked content 308 include an encrypted watermark, the watermark remains encrypted.

It is noted however, that the invention is not constrained to target selective encryption. For example, selective encryption, sometimes known as ‘soft encryption,’ ‘partial encryption,’ or ‘fractional encryption,’ may also be employed. Such selective encryption typically seeks to identify the smallest subset of a compressed bit stream that results in a desired amount of degradation of the content at a decoder, such as at a client device. However, selecting too small of a subset of the bit stream may decrease a level of security. Therefore, there may be a trade-off using this approach. Thus, selective encryption may receive compressed content and employ an encryption algorithm to encrypt that predetermined minimum amount of the bit stream that balances degradation against a desired security level.

In any event, the invention may employ any of a variety of encryption mechanisms to encrypt at least a portion of the content and/or the watermark, including asymmetric encryption mechanisms, such as, Diffie-Hellman, RSA, Merkle-Hellman, PGP, as well as symmetric encryption mechanisms, such as Advanced Encryption Standard (AES), RC6, IDEA, DES, RC2, RC5, Skipjack, and the like. The corresponding content decryption key may then be provided to the requesting client device employing any of a variety of mechanisms, including an out-of-band approach, a trusted-third party, and the like.

FIG. 4 illustrates a logical flow diagram generally showing one embodiment of a process for managing session based watermarking on targeted selectively pre-encrypted content. Process 400 of FIG. 4 may be implemented within computing device 200 of FIG. 2, as well as across content server 102 and watermarking bridge 104 of FIG. 1.

As shown in FIG. 4, process 400 begins, after a start block, at block 402, when content is received. Such content may be received from a variety of sources. For example, the content may be received from an upstream content owner, provider, and the like. At block 402, the content is examined to determine if it is compressed. If it is not, the content may be compressed at block 402. Compression of the content may employ any of a variety of compression/decompression mechanisms appropriate to a given content type. For example, block 402 may employ Moving Pictures Experts Group (MPEG), Joint Photographic Experts Group (JPEG), wavelets, and other mechanisms for compression of the received content.

Processing continues to block 404, where a determination is made whether the compressed content is targeted selectively encrypted. If it is not, then any of the approaches described above in conjunction with FIG. 3 may be employed to examine, parse, and selectively encrypt different targeted portions of the content. In one embodiment, block 404 operates to perform the encryption in real time. In another embodiment, the encryption is performed ‘off-line’ and the targeted selectively encrypted content is stored for later access. In another embodiment, selective encryption, rather than targeted selective encryption is employed.

Process 400 flows next to decision block 406, where a determination is made whether a request for the content is received. If no request for the content is received, processing loops through decision block 406, until a request is received. If a request for the content is received, processing flows to block 408 where session information is received. Session information may be received from the requesting client. Such session information may include, for example, a client unique identifier, end-user identifier, digital rights associated with the content, the end-user, and so forth. In one embodiment, the client unique identifier may include a name, a pass code, a hash, a credit card number, an Internet Protocol (IP) address associated with the client device, and the like. Session information may also be received from a content owner, content provider, and the like. Such information may include, for example, an identifier of the content owner, content encrypter, content provider, and the like.

Processing continues next to block 410, where the session information is employed to include at least one session based watermark into selective portions of the content as they are streamed towards the requesting client. As described above, a variety of different mechanisms may be employed to generate multiple watermarks into the streaming content. Moreover, the watermarks may be digitally signed and/or encrypted. Processing continues to block 412, where the watermarked content is continually streamed towards the requesting client, where the requesting client decrypts the content. Upon completion of block 412, process 400 returns to a calling process to perform other actions.

It will be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the operations indicated in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks.

Accordingly, blocks of the flowchart illustrations support combinations of means for performing the indicated actions, combinations of steps for performing the indicated actions and program instruction means for performing the indicated actions. It will also be understood that each block of the flowchart illustrations, and combinations of blocks in the flowchart illustrations, can be implemented by special purpose hardware-based systems, which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

1. A system for communicating content over a network, comprising:
a client device that is configured to perform actions, including:
requesting the content; and
providing session information associated with the request; and
a computing device that is configured to perform actions, including:
receiving the session information associated with the request;
encrypting at least a portion of the content, wherein at least another portion of the content remains unencrypted;
determining a watermark, based at least in part, on the session information; and
applying the watermark to at least a portion of the unencrypted content in real-time as the encrypted and unencrypted portions of the content are streamed towards the client device.

2. The system of claim 1, wherein encrypting at least a portion of the content further comprises selectively targeting at least the portion of the content for encryption.

3. The system of claim 1, wherein applying the watermark further comprises applying a different watermark to a different portion of the unencrypted content.

4. The system of claim 1, wherein applying the watermark further comprises applying a different watermark to the same portion of the unencrypted content.

5. The system of claim 1, wherein applying the watermark further comprises at least one of encrypting at least a portion of the watermark, and digitally signing at least another portion of the watermark.

6. The system of claim 1, wherein the computing device employs at least one of a watermarking plug-in and a watermarking bridge to apply the watermark.

7. The system of claim 1, wherein the watermark is encrypted employing a different cryptographic key than is used to encrypt the portion of the content.

8. The system of claim 1, wherein the client device is a mobile device.

9. The system of claim 1, wherein the session information further comprises at least one of a client device identifier, an end-user identifier, digital rights associated with an end-user, an end-user name, a pass code, a hash, a credit card number, and an Internet Protocol (IP) address.

10. The system of claim 1, wherein determining the watermark, further comprises determining the watermark based on additional session information further comprising at least one of an identifier of a content owner, an identifier of a content encrypter, an identifier of a content provider, and an identifier of the content.

11. A system for communicating content over a network, comprising:
a content server that is configured to perform actions, including:
receiving a request for the content from a computing device;
receiving session information associated with the request;
encrypting at least a portion of the content, wherein at least another portion of the content remains unencrypted; and
streaming the encrypted and unencrypted portions of the content towards the computing device;
a watermarking component that is configured to intercept the streamed content and to perform actions, including:
receiving the session information;
determining a watermark, based at least in part, on the session information; and
applying the watermark to at least a portion of the unencrypted content in real-time as the encrypted and unencrypted portions of the content are further streamed towards the computing device.

12. The system of claim 11, wherein the watermarking component is at least one of a watermarking bridge and a watermarking plug-in component.

13. The system of claim 11, wherein the computing device associated with the request further includes a wireless communication for receiving the streaming content.

14. An apparatus for communicating content over a network, comprising:
a processor in communication with the transceiver; and
a memory in communication with the processor for storing data and machine instructions that cause the processor to perform a plurality of operations, including:
receiving a content stream, wherein at least a portion of the content stream is encrypted, and at least another portion of the content stream is unencrypted;
receiving session information associated with the content stream;
determining a watermark, based at least in part, on the session information; and
applying the watermark to at least a portion of the unencrypted content stream in real-time as the content stream is further streamed over the network.

15. The apparatus of claim 14, wherein the apparatus is configured to operate as at least one of a watermarking bridge and a watermarking component within a computing device.

16. The apparatus of claim 14, wherein the content stream was selectively encrypted employing a targeted selective encryption mechanism.

17. The apparatus of claim 14, wherein applying the watermark further comprises applying a different watermark to a different portion of the unencrypted content.

18. The apparatus of claim 14, wherein applying the watermark further comprises at least one of encrypting at least a portion of the watermark, and digitally signing at least another portion of the watermark.

19. The apparatus of claim 14, wherein the watermark is encrypted employing a different cryptographic key than is used to encrypt the portion of the content.

20. A method for communicating content over a network, comprising:
receiving session information associated with a request for the content;
encrypting at least a portion of the content, wherein at least another portion of the content remains unencrypted;
determining a watermark, based at least in part, on the session information; and
applying the watermark to at least a portion of the unencrypted content in real-time as the encrypted and unencrypted content is streamed towards a computing device associated with the request.

21. The method of claim 20, wherein session information further comprises at least one of a client device identifier, an end-user identifier, digital rights associated with an end-user, an end-user name, a pass code, a hash, a credit card number, an Internet Protocol (IP) address, an identifier of a content owner, an identifier of a content encrypter, an identifier of a content provider, and an identifier of the content.

22. A modulated data signal for communicating content over a network, the modulated data signal comprising instructions that enable a computing device to perform the actions of:
sending, from a client device, a request for the content;
sending, from the client device, session information associated with the request;
receiving the content streamed at a watermarking component, wherein at least a portion of the content is encrypted and at least another portion of the content is unencrypted;
enabling the watermarking component to determine a watermark, based at least in part, on the session information; and
enabling the watermarking component to apply the watermark to at least a portion of the unencrypted content in real-time as the content is further streamed towards the client device over the network.

23. The modulated data signal of claim 22, wherein the watermarking component further comprises at least one of a watermarking bridge and a watermarking plug-in component.

24. An apparatus for communicating content over a network, comprising:
a means for receiving a request for the content;
a means for receiving session information associated with the request for the content;
a means for receiving the content, wherein at least a portion of the content is encrypted and at least another portion of the content is unencrypted;
a means for determining at least one watermark, based at least in part, on the session information; and
a means for applying the at least one watermark to at least a portion of the unencrypted content in real-time as the content is streamed over the network.
